(19) United States
(12) Patent Application Publication
(10) Pub. No.: US 2016/0167500 A1
(43) Pub. Date: Jun. 16, 2016

(54) Electric engine arrangement

(71) Applicant: Simone CASALI, Prignano Sul Secchia (MO) (IT)

(72) Inventor: Simone Casali, Prignano sul Secchia (MO) (IT)

(21) Appl. No.: 14/909,175

(22) PCT Filed: Aug. 1, 2013
(86) PCT No.: PCT/IB2013/056326

§ 371 Date: Feb. 1, 2016

(51) Int. Cl. B60K 6/26; B60K 17/24; H02K 7/108; H02K 16/00; H02K 9/19; B60K 1/00; B60K 6/40

(52) U.S. Cl. CPC B60K 6/26; B60K 1/00; B60K 17/24; B60K 6/40; H02K 16/005; H02K 9/19; H02K 7/108; B60Y 2200/91; B60Y 2200/92; Y10S 903/906; Y10S 903/951

(57) ABSTRACT

An electric engine arrangement includes: a first element arranged in a housing integral with a vehicle to be motorized; a second element which is rotatably mounted coaxially with the first element, and driven by a magnetic field generated between the first and second elements; motion transfer member connected to the first element and second element, the first element being mounted to rotate relative to the housing and the second element.

### FIELD OF THE INVENTION

The invention relates to an electric engine arrangement, particularly adapted to equip hybrid-powered vehicles, i.e. vehicles motorized by an internal combustion engine powered by either diesel or gasoline, and at least one electric engine, that may operate either independently of the combustion engine, or in combination therewith, to provide a higher power.

### BACKGROUND OF THE INVENTION

Electric engines have been long known and used for installation on hybrid vehicles.

These engines, that operate upon request of the control logics of vehicles, schematically consist of a stator element, which is held stationary relative to the vehicle, and a rotor element, which rotates relative to the stator and is set into rotation by a magnetic field generated between the electrical windings interposed between the stator and the rotor and powered by on-board batteries.

The rotor also has a drive shaft mechanically connected thereto, which transfers motion to a differential, through which motion is transferred to the drive wheels.

In a first arrangement, the connection between the rotor of the electric motor and the differential is a direct connection whereas, in an alternative arrangement, a gearbox may be mounted between the rotor and the differential.

In a further known arrangement, each of the drive wheels of the vehicle may be driven by a respective electric engine, which directly provides the torque to the axle shaft or to the hub of the wheel connected thereto.

In all the above described technical arrangements, the electric engine are also equipped with cooling devices which hold the operating temperatures within predetermined ranges to prevent the magnetic field strength from being limited by an excessive temperature increase.

Performance losses in electric engines are known to be basically caused by the Joule effect occurring in their parts, e.g. cables, in ferromagnetic parts due to magnetic hysteresis or due to stray currents.

This prior art provides hybrid vehicles having adequate performances, although due to the reduced life of batteries and their overall weight and cost, hybrid power is still not widespread.

In order to obviate this drawbacks, prior art hybrid vehicles feature energy recovery systems that recharge the batteries when the vehicle is powered by the internal combustion engine and when the vehicle is decelerating.

Nevertheless, this prior art suffers from certain drawbacks.

A first drawback of the electric engines as described in the first arrangement is that they can impart a low speed to the vehicle, their torque is limited to such low speeds and they have a substantially low efficiency.

A second drawback, which is typical of the alternative arrangement in which a gearbox is provided between the rotor and the differential, is that higher costs are involved as compared with the above described simpler arrangement, and the electric engine also has a higher overall weight.

In addition, as vehicles run, the gearbox absorbs part of the torque provided by the engine, due to gear friction.

A third drawback, which is typical of electric engines that power respective drive wheels of vehicles is that vehicle motorization costs are considerably higher, as at least two engines are required, and the energy required for supplying these two engines is also proportionally higher.

Therefore, high-capacity and high-power batteries should be mounted to the vehicles, which will considerably increase the overall costs of the vehicles equipped with such motorization arrangement.

Furthermore, the arrangement in which electric engines are installed directly on the wheels, with no axle shafts therebetween involves an increased weight of the so-called unsprung masses, i.e. the elements that form the suspensions of vehicles.

This will cause an increase of the mechanical stresses from the ground, that act upon the suspensions and must be absorbed thereby.

Therefore, the parts of the suspensions must be effectively strengthened, which means that the arms, the tie rods, the shock absorbers and the connecting elements must have larger sizes, thereby further increasing the overall costs.

A fourth drawback is that electric engines are not easily cooled, whereby their performance, which is considerably affected by high temperatures, is lower due to the high temperatures at which they are typically designed to operate.

A fifth drawback is that batteries can be only recharged when the vehicles are moving and are being powered by the combustion engine, or when they are decelerating and are being powered either by the electric engine only or by the combustion engine only.

### OBJECTS OF THE INVENTION

One object of the invention is to improve the state of the art.

Another object of the invention is to provide an electric engine arrangement that can considerably simplify the structure of electric engines, particularly electric engines designed for hybrid motorization of vehicles.

A further object of the invention is to provide an electric engine arrangement that provides improved cooling as compared with the prior art, which improves its overall performance.

A further object of the invention is to provide an electric engine arrangement in which batteries may be also recharged when the vehicle is still.

Yet another object of the invention is to provide an electric engine arrangement that has a light weight, a low cost and may be easily adapted to the various construction arrangements that are currently used by vehicle manufacturers, with no particular adaptation problem.

A further object of the invention is to provide an electric engine arrangement that allows removal of the starter, the alternator, the usual battery, the clutch and the gearbox, and in certain cases also the differential from hybrid vehicles, which affords reduction of the manufacturing and sales costs of such hybrid vehicles and will considerably increase their presence on the market, while reducing the environmental impact of and the dependence on fuels derived from oil refining.

In one aspect the invention relates to an engine arrangement as defined in the features of the independent claim 1.

Further detailed features are described in the dependent claims.

Therefore, the invention affords the following advantages:

it simplifies the structure of hybrid power vehicles, thereby reducing their overall cost;

it increases the number of revolutions of the engine arrangement;

it increases the efficiency of the engine arrangement as compared with the efficiencies of prior art electric engines;

in certain cases, it removes the differential from the motion transfer members of hybrid vehicles, in addition to the clutch and the gearbox, the starter, the alternator and the usual battery;

it automatically generates flows of a cooling fluid for cooling the electric engine arrangement, thereby improving its performance;

it can be adapted to any hybrid motorization solution.

### DESCRIPTION OF THE DRAWINGS

Further characteristics and advantages of the invention will be more apparent upon reading of the detailed description of an electric engine arrangement of the invention, which is illustrated by way of example and without limitation in the annexed highly schematic drawings, in which:

FIG. 1 is a view of a first basic embodiment of an electric engine arrangement of the invention, which may be used to power an electric vehicle;

FIG. 2 is a view of a first possible embodiment of a hybrid vehicle, which is equipped with both a combustion engine and with the electric engine arrangement of the invention;

FIG. 3 is the embodiment of FIG. 2, with the combustion engine being started using the electric engine arrangement of the invention;

FIG. 4 is the embodiment of FIG. 2, with the vehicle being powered by the combustion motor only;

FIG. 5 is the embodiment of FIG. 2, during a power generating step for recharging the batteries using the combustion engine, but with the vehicle stopped;

FIG. 6 is the embodiment of FIG. 5, with the vehicle being powered by the combustion engine only, with simultaneous power co-generation for recharging the batteries that supply power to the electric engine arrangement of the invention;

FIG. 7 is the embodiment of FIG. 2, with the vehicle being powered simultaneously by the combustion engine and the electric engine arrangement of the invention;

FIG. 8 is the embodiment of FIG. 2, with the vehicle being powered by the electric engine arrangement of the invention;

FIG. 9 is the embodiment of FIG. 2, with the vehicle being powered by the electric engine arrangement of the invention and with the combustion engine being simultaneously started;

FIG. 10 is the embodiment of FIG. 2, with the batteries of the vehicle being recharged while the vehicle slows down, with the combustion engine off;

FIG. 11 is the embodiment of FIG. 1, in which a clutch unit has been interposed between the driving wheels;

FIG. 12 is a further possible embodiment of a hybrid vehicle, having a control on the driving wheels;

FIG. 13 shows an embodiment of a cooling system for the electric engine arrangement of the invention.

### PREFERRED EMBODIMENTS OF THE INVENTION

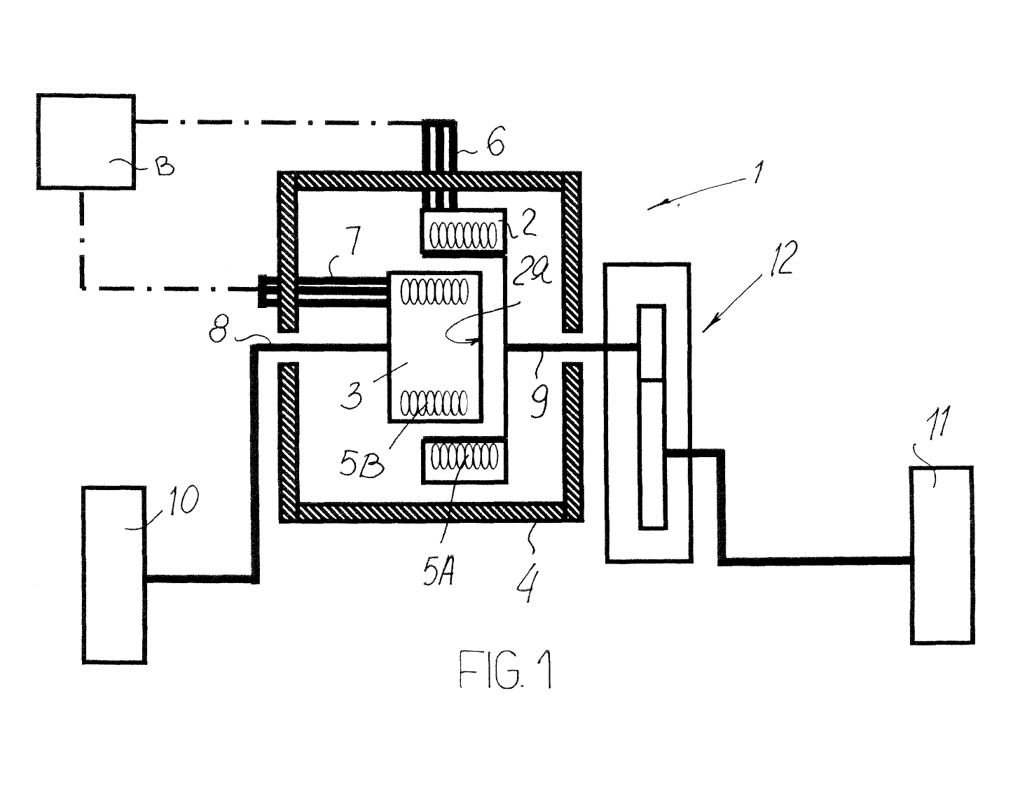

Referring to FIG. 1, numeral 1 generally designates an electric engine arrangement, particularly an electric engine arrangement adapted for use in purely electric or hybrid power vehicles.

As shown in FIG. 1, the electric engine arrangement 1, hereinafter simply electric engine 1 comprises a first hollow cylindrical element 2, hereinafter simply first element 2, and a second solid cylindrical element 3, which is substantially coaxially arranged within the cavity 2a of the first element 2.

Both first and second elements 2 and 3 are in turn accommodated in a housing 4 that supports them and is attached to the chassis (not shown) of a vehicle.

Both the first element 2 and the second element 3 rotate relative to the housing 4 but in opposite directions of rotation, as better explained hereinafter.

According to the invention, both elements 2 and 3 are subjected to magnetic forces, which cause them to rotate in opposite directions, as mentioned above.

The skilled person will understand that these magnetic forces are generated by a magnetic field created, for instance, by respective electric windings 5A and 5B arranged in one of the two elements 2 and 3 or both, as schematically shown in FIG. 1, and powered by respective batteries “B”, or other accumulators carried on board the vehicle and connected thereto by respective connecting lines 6 and 7.

As shown in FIG. 1, both the first element 2 and the second element 3 are mechanically connected to respective drive shafts 8 and 9, which receive therefrom the rotary drive motion and transfer it to respective driving wheels 10 and 11.

It shall be noted that, since the rotary motions are oppositely directed, either of the element 2 and 3 and its respective driving wheel 10 or 11, shall be equipped with a motion reversing unit, referenced 12, which is mounted between the drive shaft 9 and the wheel 11, as shown for merely illustrative purposes in FIG. 1.

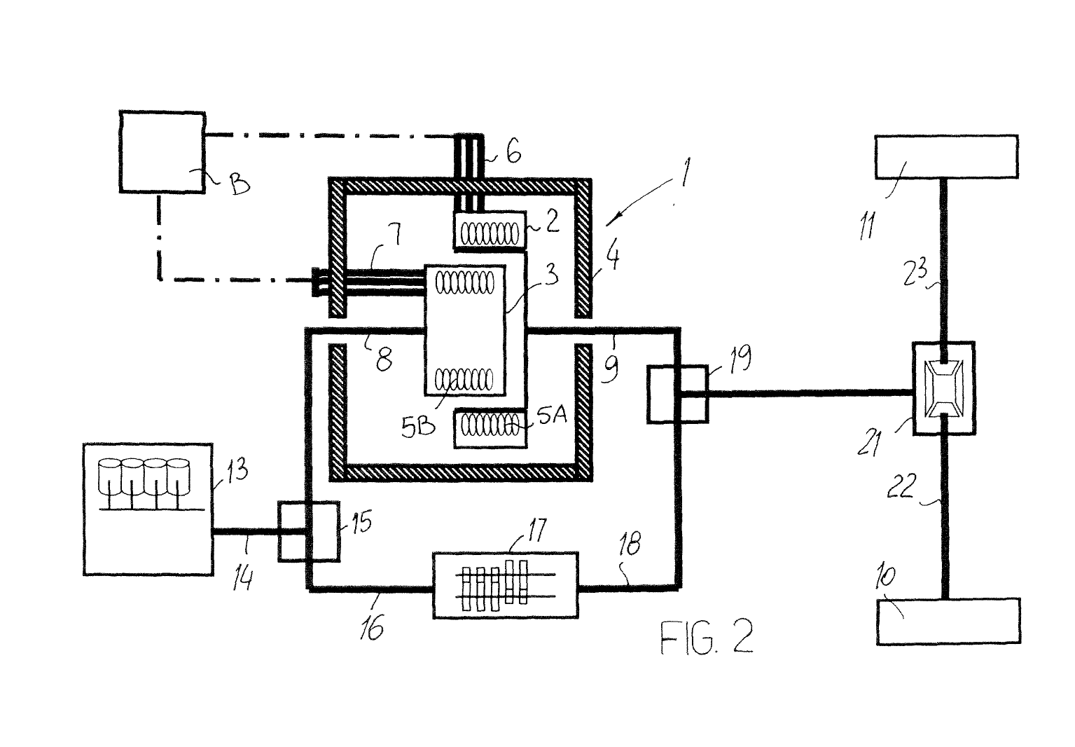

Referring to FIG. 2 in which, like in all the following figures, equal parts are designated by equal references, it shall be noted that the electric engine is mounted to a theoretical hybrid vehicle, in combination with a combustion engine 13 from which an additional drive shaft 14 draws motion.

In this embodiment, the first element 2 is connected by its own rotating shaft 8 to the output of the drive shaft 14 through a connect/disconnect unit 15 and from the latter, through an additional drive shaft 16, to the gears of a gearbox 17.

A further drive shaft 18 comes out of this gearbox 17 and fits into a further connect/disconnect unit 19 having a final drive shaft 20 that comes out of it and fits into a differential 21.

Two axle shafts 22 and 23 come out of the differential 21 and connect to the driving wheels 10 and 11 respectively to transfer motion thereto.

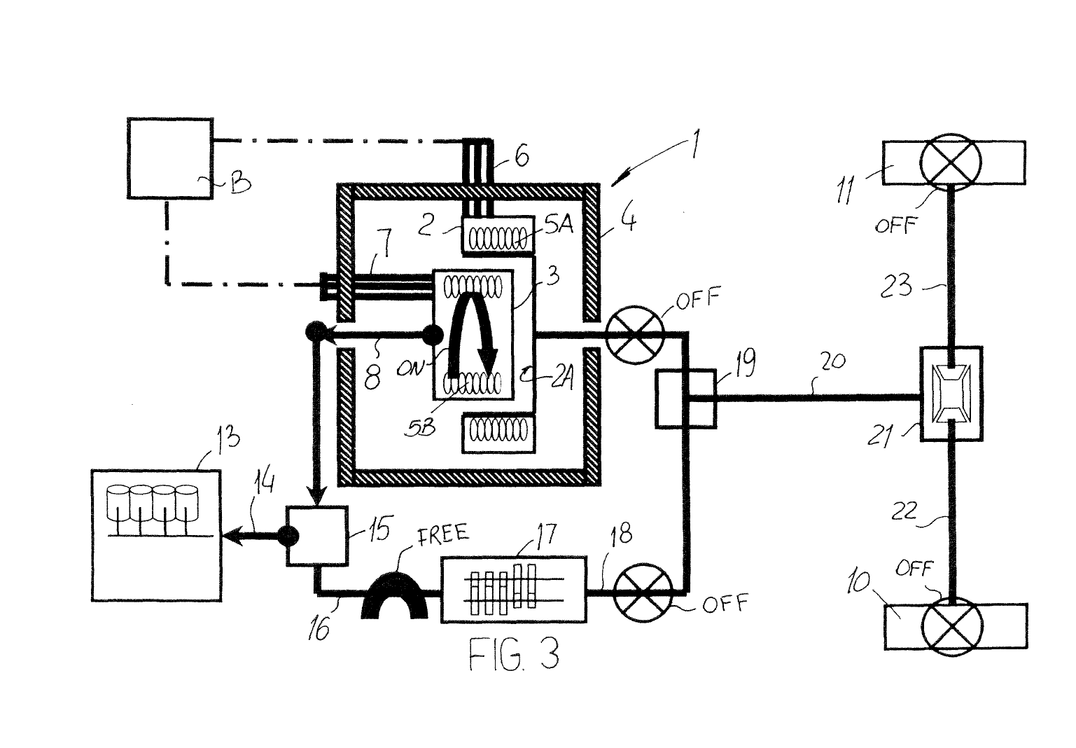

In FIG. 3 and in all the other figures, four graphic symbols are generally, but not necessarily simultaneously used, to conventionally and schematically designate an operating condition of a member, to which each symbol is related.

In greater detail, it shall be intended hereinafter that:

a twisted arrow designated by “ON” conventionally indicates that the relevant member is in a torque generation state; whereas

a cross in a circle, and designated by “OFF” conventionally indicates that the relevant member is in a locked state; whereas

an inverted “U” designated by “FREE” conventionally indicates that the relevant member is in a freely rotating state, with no torque generation or absorption; whereas

a square with a twisted arm designated by “IN” conventionally indicates that the relevant member is in a torque absorption state.

Furthermore, arrows have been added to the segments that designate all the drive shafts to indicate, for each operating state, the direction of active torque transmission, to or from one of the vehicle members.

In view of the above, FIG. 3 shows, for instance, the start condition of the combustion engine 13, using the electric engine 1 and with the vehicle stopped.

In this condition, it shall be noted that the second element 3, which is powered by batteries through the power lines 8, is in a torque generation state, with torque being transferred through the drive shafts 8 and 14 to the combustion engine 13, whereas the drive shaft 16 is idle, i.e. rotates freely with no torque generation or absorption; at the same time, the drive shafts 9 and 18 and accordingly the driving wheels 10 and 11 are locked.

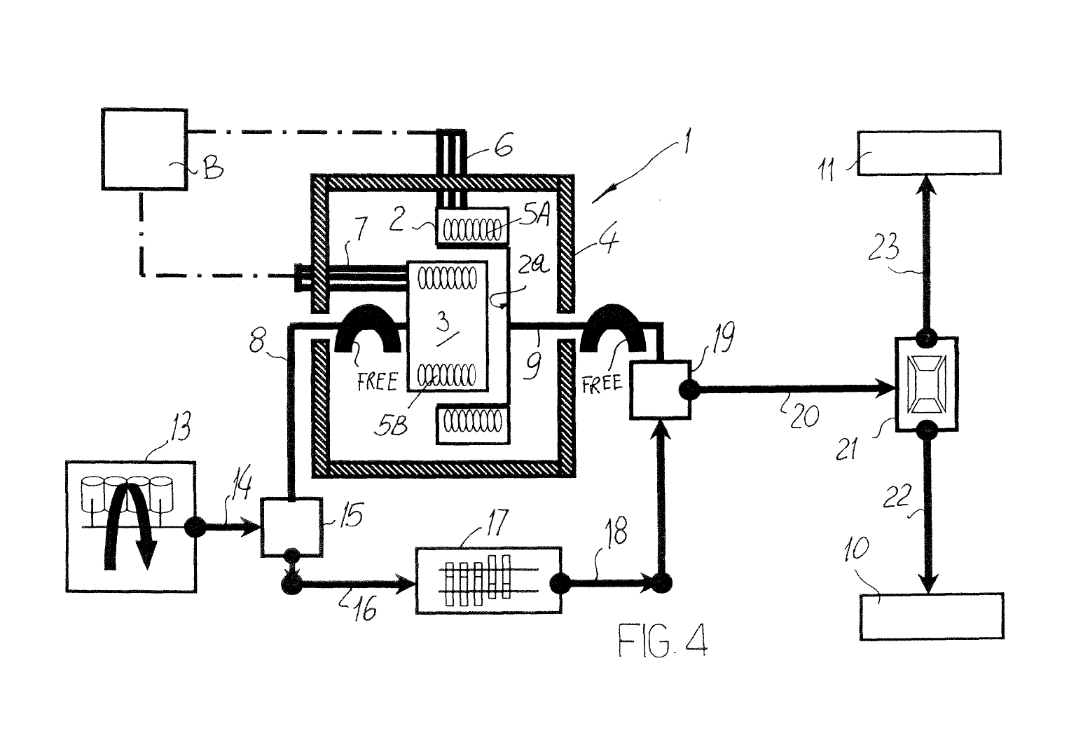

FIG. 4 shows the state in which the vehicle is powered by the combustion engine 13 only.

In this configuration, the combustion engine 13 generates a torque, as shown by the “ON” symbol, which is transferred to the gearbox 17 through the drive shafts 14 and 16 and from the gearbox to the drive shaft 18 and then to the drive shaft 20, to the differential 21, to the axle shafts 22 and 23 and finally to the driving wheels 10 and 11.

At this time, it shall be noted that both the drive shaft 8 and the drive shaft 9 are idle: therefore, in this case the electric engine 1 is not used.

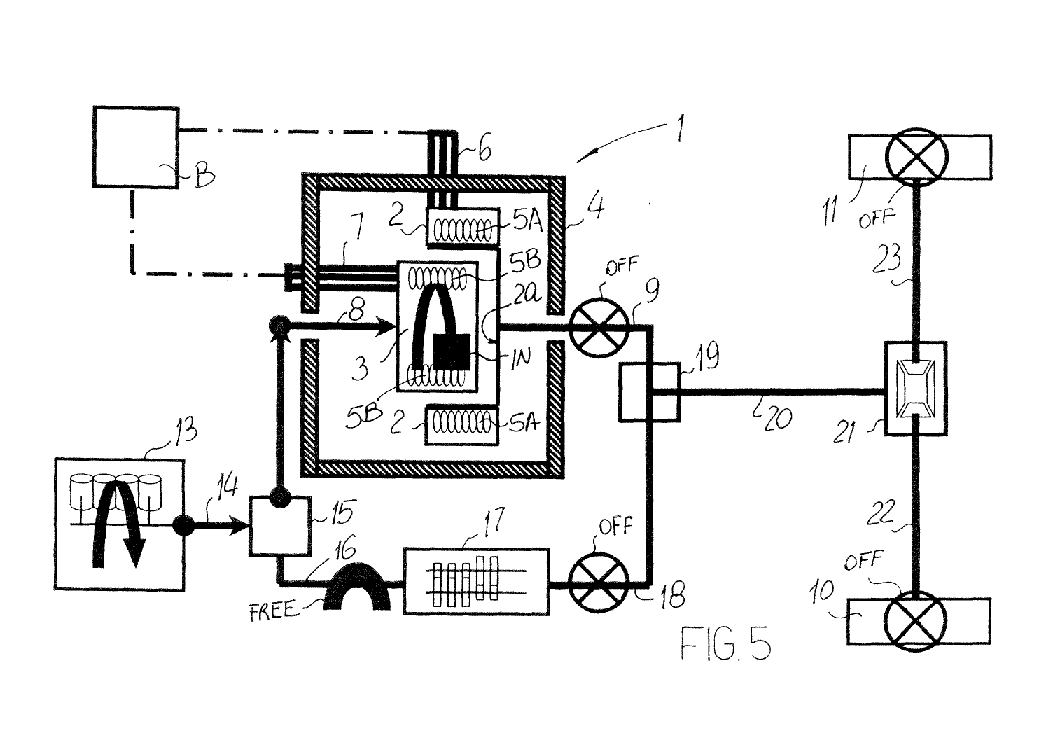

FIG. 5 shows a power generation state with the vehicle stopped, i.e. in other words a battery “B” recharging state.

It will be noted that, in this state, the combustion engine 13 generates a torque, as shown by the “ON” symbol, which is transferred to the second element 3 of the electric engine 1 through the shafts 14 and 8, and that this second element 2 absorbs the torque, as shown by the “IN” symbol.

In this state, the second element 3 sends power to the batteries through the lines 7.

At the same time, the first element 2 is locked, because the drive shaft 9 and the drive shaft 18 that comes out of the gearbox 17 are also locked: this state is designated by corresponding “OFF” symbols which are placed on the driving wheels 10 and 11 to indicate that the latter are also locked, in this state.

On the other hand the drive shaft 16 is idle, and transfers no torque to the gearbox 17.

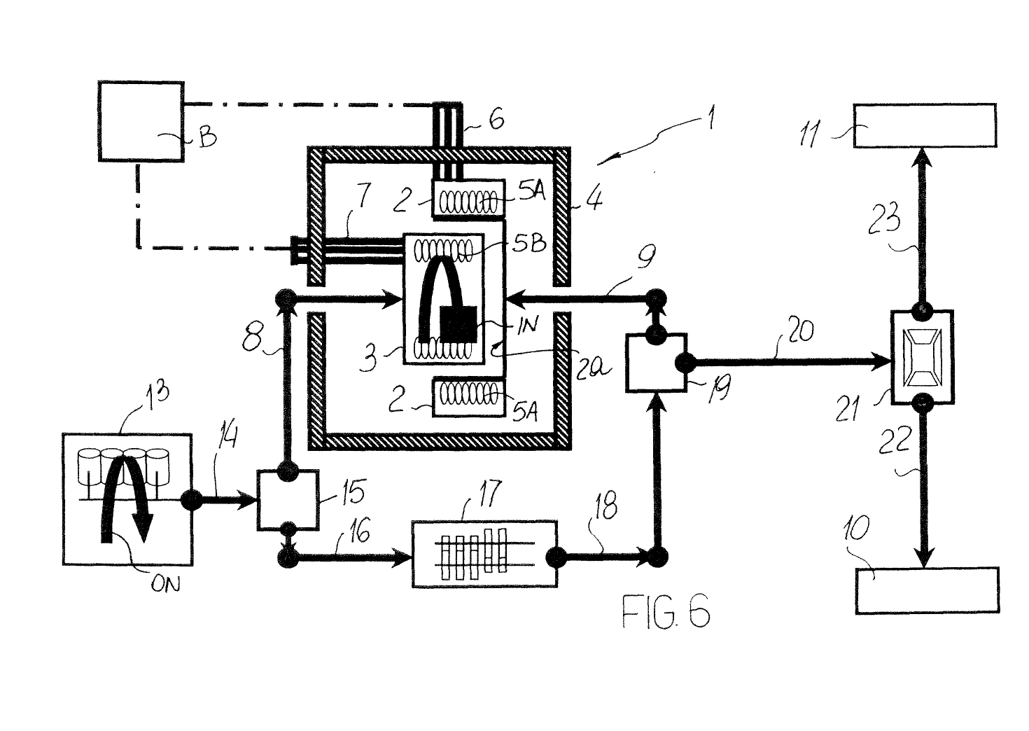

FIG. 6 shows a state in which the vehicle is only powered by the combustion engine 13 which generates the torque designated by the “ON” symbol which torque is transferred to the driving wheels 10 and 11 through the drive shafts 14 and 16, the gearbox 17, the further drive shafts 18 and 20, the differential 21 and the axle shafts 22 and 23.

At the same time, in this state the electric engine 1 receives the torque, as shown by the “IN” symbol, which torque is provided by the drive shaft 8 and the drive shaft 9 through the first element 2 and the second element 3.

The torque powers the generators of the batteries of the vehicle, via the connecting lines 6 and 7.

In this state, the vehicle is moving and at the same time the batteries are being recharged.

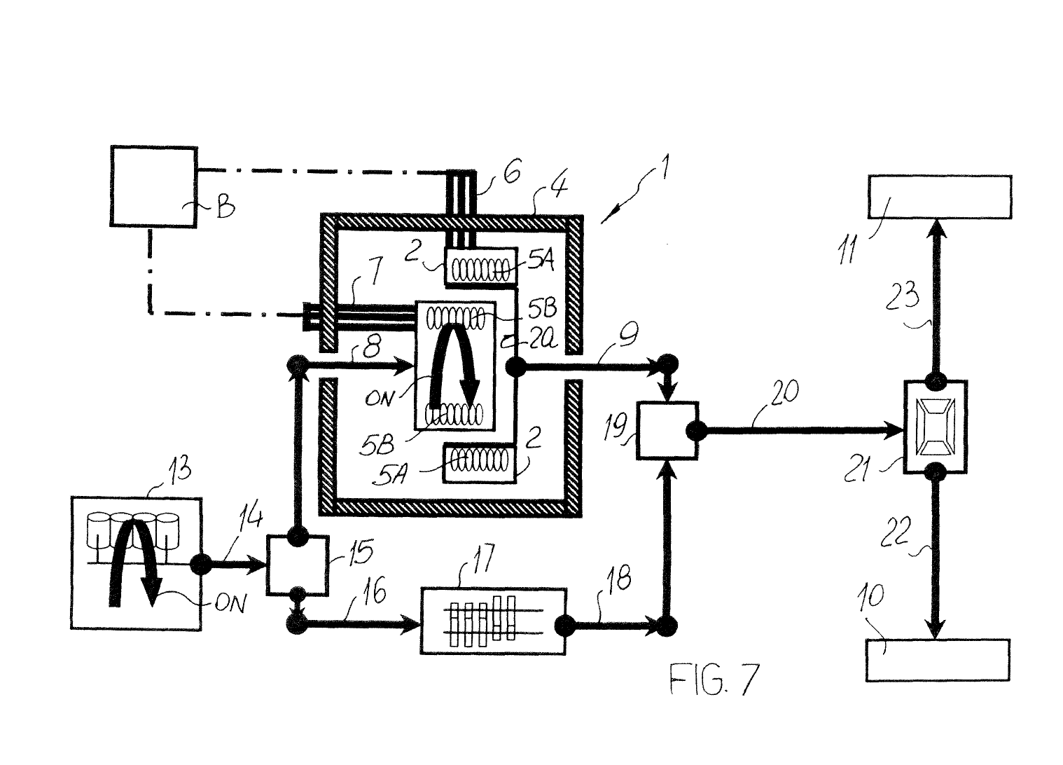

FIG. 7 shows a state in which the vehicle is moving and torque is co-generated, by both the combustion engine 13 and the electric engine 1.

It may be noted in greater detail that, in this state, the combustion engine 13 is operating and generates a torque, which is transferred to the gearbox 17 through the drive shafts 14 and 16, the latter being connected together by the connect/disconnect unit 15.

The torque is transferred from the gearbox 17 to the differential 21 and from the latter to the driving wheels 10 and 11 through the two drive shafts 18 and 20, which are connected to each other by the connect/disconnect unit 19 and the two axle shafts 22 and 23.

As shown in FIG. 7, the torque generated by the combustion engine 13 is also transferred to the electric engine 1 through the drive shaft 8 that will rotate the second element 3, the latter setting the first element 2 into counter-rotation.

This element will transfer an additional torque to the differential 21 through the drive shaft 9 and the connect/disconnect unit 19 which, in this state, joins the drive shaft 9 to the drive shafts 18 and 20.

In this configuration, the vehicle has the maximum power, co-generated by both the combustion engine 13 and the electric engine 1.

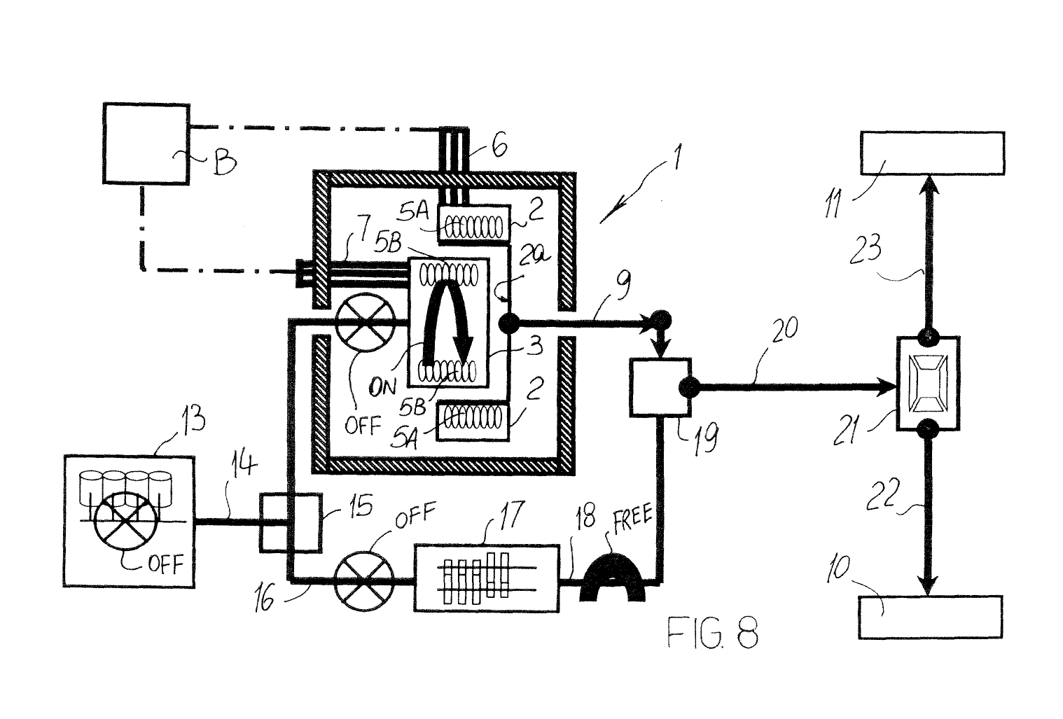

FIG. 8 shows a state in which the vehicle is only electrically powered.

In greater detail, in this state, the combustion engine 13 is off, as shown by the “OFF” symbol and the drive shafts 8 and 16 are also still.

The drive shaft 18 is idle, as indicated by the “FREE” symbol and the gearbox 17 is also deactivated.

Thus, the vehicle is only powered by the torque provided by the electric engine 1, which transfers it to the differential 21 through the drive shafts 9 and 20 connected together by the connect/disconnect unit 19.

Then the torque is transferred from the differential 21 to the driving wheels 10 and 11 through the axle shafts 22 and 23.

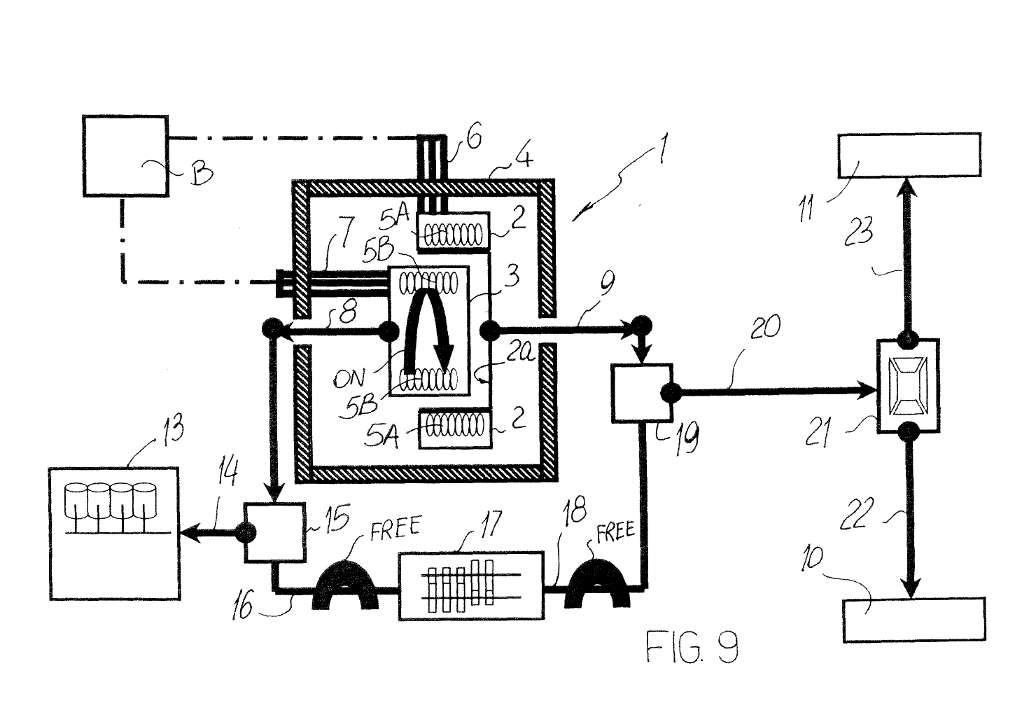

FIG. 9 shows the state in which the vehicle is electrically powered and the combustion engine 13 is simultaneously started.

This state is known to occur when the battery charge is strongly reduced once the vehicle has run a road section with the electric power only.

Referring to FIG. 9, the electric engine 1 is synthetically shown in a torque generation state, designated by the “ON” symbol, the torque being transferred to the differential 21 and the driving wheels 10 and 11 through the two drive shafts 9 and 20.

The two drive shafts 16 and 18 are both idle, i.e. free to rotate with no torque transfer or absorption, and the gearbox 17 is deactivated.

The directions of the arrows as shown on the drive shafts 8 and 14 show that part of the torque generated by the electric engine 1 is transferred to the combustion engine 13, which thus receives the force required for starting.

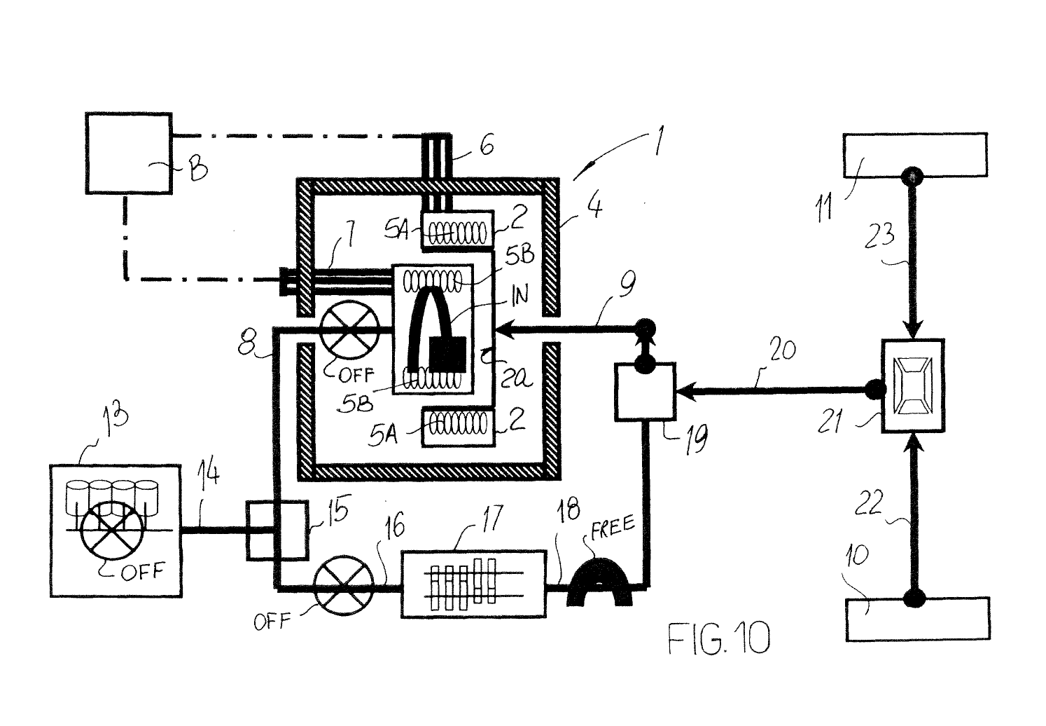

FIG. 10 shows a state of power regeneration of the batteries of the vehicle, as provided by the kinetic reaction thereof during idle driving, e.g. in a downhill road section.

In this state, as indicated by the directions of the arrows on the drive shafts 20 and 9, the driving wheels 10 and 11 rotate the first element 2 and accordingly also the second element 3, and the electric engine 1 supplies power to the batteries “B” of the vehicle through the connecting lines 6 and 7.

Now, the combustion engine 13 is off, the two drive shafts 8 and 16 are locked, the drive shaft 18 is idle and the gearbox 17 is deactivated.

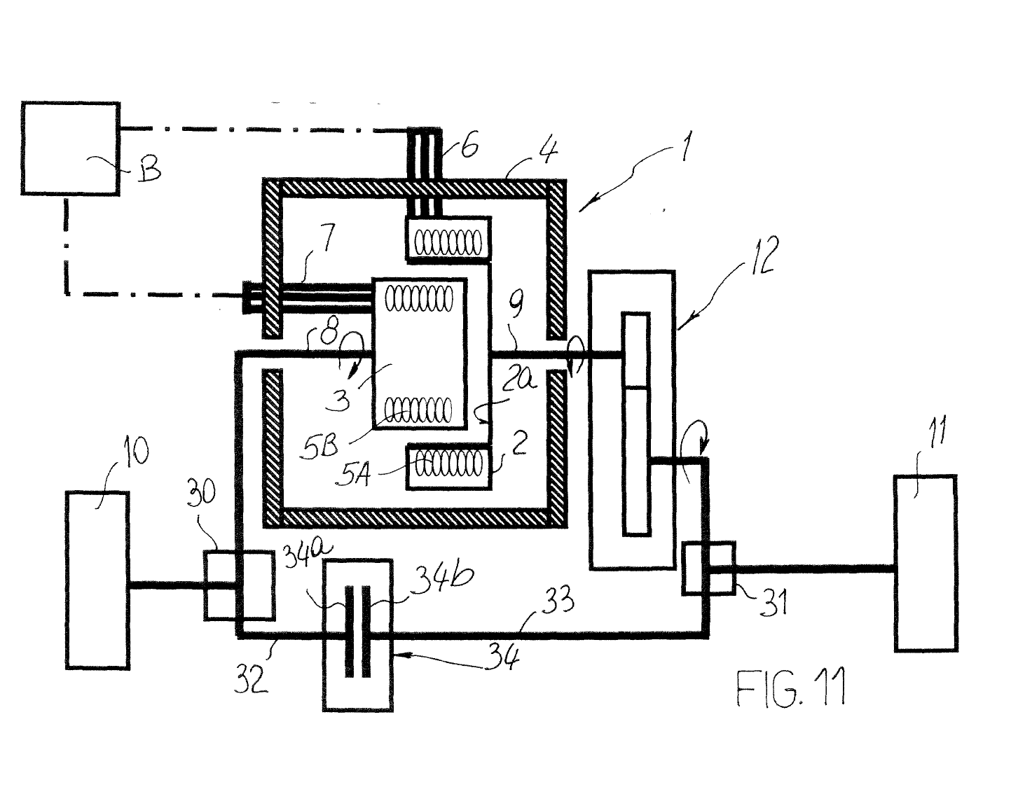

FIG. 11 shows a variant embodiment of the vehicle of FIG. 1, namely an embodiment that is only powered by the electric engine 1 and has a clutch between the two driving wheels 10 and 11 for drive control thereof under poor road grip conditions.

As shown herein, the torque generated by the electric engine 1 is transferred to the driving wheels 10 and 11 by the drive shafts 8 and 9, as described above.

Nevertheless, two additional drive shafts 32 and 33 are connected to these drive shafts 8 and 9, through corresponding additional connect/disconnect units 30 and 31, which are designed to connect or disconnected the shafts 8 and 9 to and from the shafts 32 and 33 as needed.

The latter are in turn connected to the clutch 34, namely to the two disks 34a and 34b thereof.

In normal grip conditions, the vehicle is driven by both driving wheels 10 and 11, the clutch 34 is deactivated and the additional connect/disconnect units 30 and 31 keep the drive shafts 32 and 33 disconnected from the corresponding drive shafts 8 and 9.

When one of the two driving wheels 10 and 11 skids, both connect/disconnect units 30 and 31 automatically connect the two drive shafts 32 and 33 to the corresponding drive shafts 8 and 9 and at the same time the clutch 34 is activated.

The latter progressively brings both disks 34a and 34b into mutual connection, according to the torque that the driving wheel in firm contact with ground is designed to transfer to the one that has no grip thereon, for the latter to also rotate and drive the vehicle.

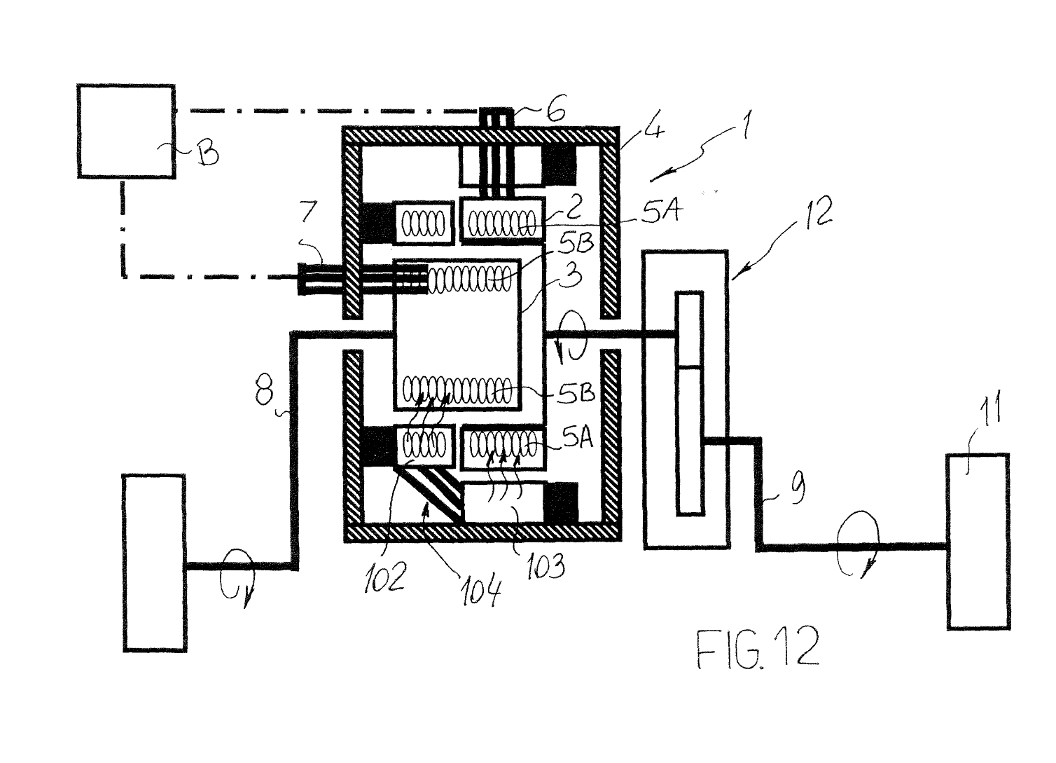

FIG. 12 shows a further variant embodiment of an solely electric vehicle powered by the electric engine 1 of the invention, as shown in FIG. 1.

In this additional embodiment, both the first element 2 and the second element 3 are accommodated in two respective magnetically active elements 102 and 103.

As used herein, the term magnetically active is intended to mean that the two elements 102 and 103 are designed to generate two additional magnetic fields that separately act upon the first element 2 and the second element 3 to affect their rotating speed.

Preferably, the two additional elements 102 and 103 are mounted in stationary fashion in the housing 4 and are also connected to each other by a power line 104 that has the purpose of transferring power between these two additional elements 102 and 103 to change the strengths of the magnetic fields generated between the latter and their respective first element 2 and second element 3.

This will afford automatic control of the torques generated between the first element 2 and the second element 3 and transferred to the driving wheels 10 and 11, by changing the strengths of the magnetic fields between the two elements 2 and 3 and the two additional elements 102 and 103.

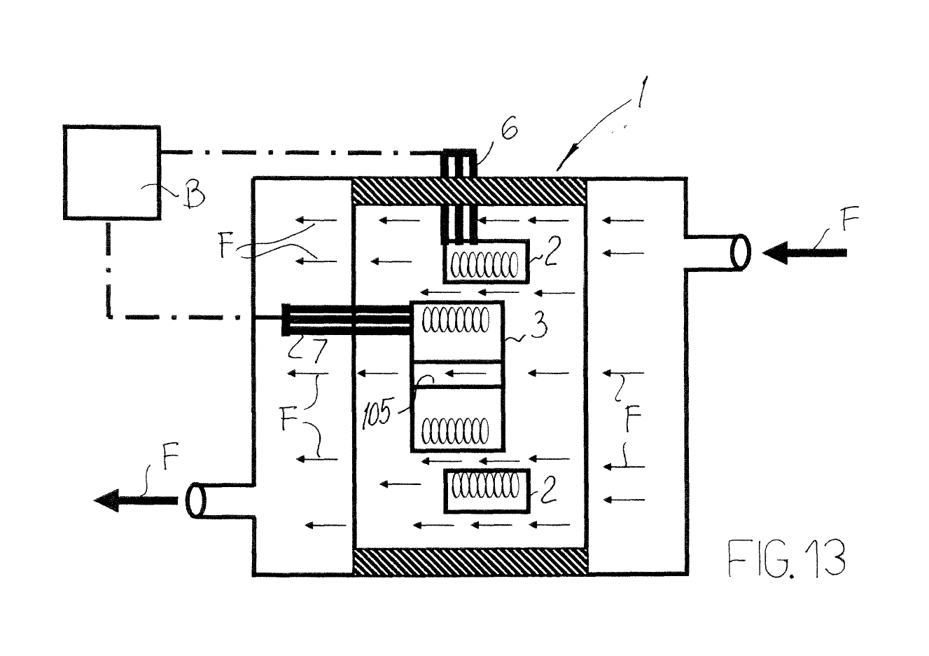

FIG. 13 shows a very synthetic diagram of a possible embodiment for cooling the electric engine 1.

The first element 2 and the second element 3 automatically generate, by their counter-rotation, a flow of cooling fluid, whose direction is designated by arrows “F”, which flow is conveyed into the housing 4 as is known to the skilled person, who may also envisage to form peripheral fins on the first element 2, the second element 3 or both, sad fins being oriented to impart a greater thrust on the cooling fluid, and channels 105 across them, to allow the flow “F” of cooling liquid to pass both outside and inside them.

It shall be noted that the skilled person may use its skill to envisage practical embodiments of the two elements 2 and 3 and any further elements 102 and 103, to generate magnetic fields therebetween, having enough strength as to cause rotation thereof and generation of torques.

Nevertheless, these embodiments do not fall within the scope of the present invention and cannot change its principle.

The invention was found to fulfill the intended objects.

The invention so conceived is susceptible to a number of changes and variants within the inventive concept.

Furthermore, all the details may be replaced by other technically equivalent parts.

In practice, any materials, shapes and sizes may be used as needed, without departure from the scope of the following claims.

The invention claimed is:

1. An electric engine arrangement (1) comprising:
a housing operatively coupled to equipment to be motorized;
a first magneto-sensitive element (2), and a second magneto-sensitive element (3), arranged in said housing (4) and reciprocally magnetically interacting by magnetic elements (5A, 5B) which have a magnetic intensity and which are born between said first and second magneto-sensitive element (2, 3), said second element (3) rotating with respect to said first magneto-sensitive element (2) and housing (4); and
a rotational motion transmission member (9) associated to said magneto-sensitive second element (3);
wherein said first element (2) is rotationally arranged with respect of said housing (4) and second magneto-sensitive element (3), is actuated by said magnetic elements (5A, 5B), and is equipped with a motion transmission system (8).

2. The electric engine arrangement according to claim 1, wherein said first element (2) and second element (3) are coaxially arranged.

3. The electric engine arrangement according to claim 1, wherein said first magneto-sensitive element (2) and second magneto-sensitive element (3) are rotationally actuated by said magnetic elements (5A, 5B) in opposite rotation directions.

4. The electric engine arrangement according to claim 1, wherein said motion transmission member and system comprise:
a first shaft transmission system (8) fitted between said first magneto-sensitive element (2) and a first element (10) to be motorized;
a second shaft transmission system (9) fitted between said second magneto-sensitive element (3) and a second element (11) to be motorized; and
at least a motion inverter device (12) selectively arranged on said first transmission shaft system (8) or second transmission shaft system (9), so as to cause concordant rotation directions.

5. The electric engine arrangement according to claim 4, wherein said first element to be motorized and said second element to be motorized comprise driving wheels (10, 11) of a vehicle.

6. The electric engine arrangement according to claim 5, wherein said first transmission shaft system and second transmission shaft system comprise respective transmission shafts (8, 9) having correspondent ends respectively connected to said second magneto-sensitive element (3) and first magneto-sensitive element (2) and opposite end respectively connected to one of said driving wheels (10, 11).

7. The electric engine arrangement according to claim 1, wherein said housing (4) comprises one inlet and one outlet for a refrigerator fluid (F), and wherein said first and said second element (2, 3) are so shaped to create by rotations of at least one of said first or second magneto-sensitive element (2, 3) a flow of said refrigerator fluid (F) flowing through said housing (4).

8. The electric engine arrangement according to claim 1, wherein said first magneto-sensitive element (2) and magneto-sensitive second element (3) comprise additional magnetic elements (102, 103) designed to adjust said magnetic intensity.

9. The electric engine arrangement according to claim 4, wherein an engaging/disengaging system (30, 31, 32, 33, 34) that selectively engage said first transmission shaft system (8) with said second transmission shaft system (9) is arranged between said first transmission shaft system (8) and second transmission shaft system (9).

10. The electric engine arrangement according to claim 9, wherein said engaging/disengaging system comprises a clutch (34).

11. A vehicle comprising:
an electric engine arrangement (1) according to claim 1.

12. The vehicle according to claim 11, further comprising:
a fuel combustion engine (13); and
a motion transmission arrangement (14, 16, 17, 18, 20 22, 23) adapted to driving wheels (10, 11) which is configured to be engaged to said fuel combustion engine (13) by a selective engaging system (15),
the electric engine arrangement being associated in parallel to said fuel combustion engine, said electric engine arrangement being selectively:
jointly or separately actuatable with said fuel combustion engine (13), and
engageable with said transmission arrangement (14, 16, 17, 18, 20 22, 23).
